(19) United States
(12) Patent Application Publication
(10) Pub. No.: US 2025/0331038 A1
(43) Pub. Date: Oct. 23, 2025

(54) PEER-TO-PEER NETWORK WITH WI-FI EXTENDED SPECTRUM

(71) Applicant: Cisco Technology, Inc., San Jose, CA (US)

(72) Inventors: Domenico Ficara, Essertines-sur-Yverdon (CH); Amine Choukir, Ecublens (CH); Roberto Muccifora, Ropraz (CH); Sachin D. Wakudkar, St-Sulpice (CH); Pascal Thubert, Roquefort-les-Pins (FR); Jerome Henry, Pittsboro, CA (US)

(21) Appl. No.: 18/643,925

(22) Filed: Apr. 23, 2024

(51) Int. Cl. H04W 76/14

(52) U.S. Cl. CPC H04W 76/14

(57) ABSTRACT

Devices, systems, methods, and processes for establishing peer-to-peer (P2P) networks over Wi-Fi extended spectrum. P2P networks often encounter challenges in meeting their bandwidth requirements, resulting in degraded performance, slower data transfer rates, or even connectivity issues. Therefore, by delegating frequency channels in the Wi-Fi extended spectrum for establishing P2P networks, at least some challenges faced by the P2P networks can be overcome. Access points (APs) in automated frequency coordination (AFC) infrastructure may coordinate with network devices intending to establish P2P connections and may allocate unused or underutilized channels in the Wi-Fi extended spectrum to these network devices for establishing the P2P connections. The APs may set usage conditions on the allocated channels which the network devices and the APs monitor once the P2P connections are established. The APs may further monitor network traffic on the allocated channels and allow concurrent P2P connections on the same channel to improve channel utilization.

The present disclosure relates to wireless communications. More particularly, the present disclosure relates to establishing peer-to-peer (P2P) networks over Wi-Fi extended spectrum.

### BACKGROUND

Peer-to-peer (P2P) networks are decentralized wireless networks where devices communicate directly with each other via adhoc connections and without the need for a central access point. These networks are often formed dynamically, allowing devices to join and leave the network on the fly. P2P networks foster flexibility, scalability, and resilience, making it suitable for scenarios ranging from file sharing to emergency communications.

Typically, bandwidth requirements of a P2P network vary based on the nature of the communication and the applications involved. For example, P2P file sharing often requires substantial bandwidth to facilitate rapid exchange of large files between connected devices. Similarly, real-time applications such as video conferencing or online gaming necessitate sufficient bandwidth to support smooth, uninterrupted communication streams.

However, the bandwidth available for P2P networks is often constrained by various factors such as spectrum availability and regulatory limitations on the use of specific frequency bands. These limitations can lead to bandwidth scarcity, particularly in congested wireless environments. Consequently, P2P networks may encounter challenges in meeting their bandwidth requirements, resulting in degraded performance, slower data transfer rates, or even connectivity issues.

### SUMMARY OF THE DISCLOSURE

Systems and methods for establishing peer-to-peer (P2P) networks over Wi-Fi extended spectrum in accordance with embodiments of the disclosure are described herein. In some embodiments, a device includes a processor, a network interface controller configured to provide access to a network, and a memory communicatively coupled to the processor, wherein the memory includes a peer-to-peer (P2P) connection logic that is configured to receive, from a network device, a channel availability request for establishing a P2P connection, determine, based on the channel availability request, one or more channels in a Wi-Fi extended spectrum that are available, and transmit, to the network device, at least a list of the one or more channels selectable for establishing the P2P connection.

In some embodiments, the P2P connection logic is further configured to transmit power information associated with at least one of the one or more channels.

In some embodiments, the P2P connection logic is further configured to receive a channel selection response configured to indicate a selection of at least one channel of the one or more channels.

In some embodiments, the channel selection response is further configured to indicate at least one of a bandwidth utilization, a duration of utilization of the at least one channel, or an identifier of a peer device for establishing the P2P connection.

In some embodiments, the P2P connection logic is further configured to transmit an acknowledgement to the network device, and wherein the acknowledgement includes an approval to utilize the at least one channel for the P2P connection.

In some embodiments, the P2P connection logic is further configured to set a coverage area for the at least one channel such that the network device is permitted to communicate on the at least one channel within the coverage area.

In some embodiments, the P2P connection logic is further configured to communicate information associated with the coverage area to the network device.

In some embodiments, the P2P connection logic is further configured to receive one or more management frames from the network device, and wherein at least one of the one or more management frames is configured to indicate one or more characteristics of an intended network traffic for the P2P connection.

In some embodiments, the P2P connection logic is further configured to predict a channel utilization value for the intended network traffic of the at least one channel.

In some embodiments, the P2P connection logic is further configured to compare the predicted channel utilization value with a threshold utilization value.

In some embodiments, in response to the predicted channel utilization value being less than the threshold utilization value, the P2P connection logic is further configured to offer the at least one channel to one or more other network devices for concurrent P2P connection establishment.

In some embodiments, in response to the predicted channel utilization value being greater than or equal to the threshold utilization value, the P2P connection logic is further configured to declare the at least one channel unavailable for an additional P2P connection.

In some embodiments, the P2P connection logic is further configured to receive an indication of a power that the network device intends to utilize on the at least one channel.

In some embodiments, the P2P connection logic is further configured to establish a radio frequency impact zone for the network device based on the indication of the power, and determine, based on the radio frequency impact zone, a threshold count of connected network device pairs allowed to coexist in a geographical area.

In some embodiments, a peer-to-peer (P2P) connection logic is configured to transmit, to a network device, a channel availability request for establishing a P2P connection, receive, from the network device, at least a list of one or more channels available in a Wi-Fi extended spectrum for establishing the P2P connection, select at least one channel from the list of one or more channels, and establish the P2P connection on the at least one channel with a peer device.

In some embodiments, the P2P connection logic is further configured to release the at least one channel based on an expiration of an allocated utilization duration.

In some embodiments, the P2P connection logic is further configured to release the at least one channel based on the device crossing a geographical boundary associated with the at least one channel.

In some embodiments, the P2P connection logic is further configured to detect a location of the device, and determine whether the device has crossed the geographical boundary based on the detected location.

In some embodiments, the device and the peer device are each associated with a unique network device.

In some embodiments, a method includes receiving, from a network device, a channel availability request for establishing a peer-to-peer (P2P) connection, determining, based on the channel availability request, one or more channels in a Wi-Fi extended spectrum that are available, and transmitting, to the network device, at least a list of the one or more channels selectable for establishing the P2P connection.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual block diagram illustrating a wireless communication network in accordance with various embodiments of the disclosure;

FIG. 2 is a conceptual block diagram illustrating a peer-to-peer (P2P) connection established over Wi-Fi extended spectrum in accordance with various embodiments of the disclosure;

FIG. 3 is a conceptual block diagram illustrating a P2P connection established over Wi-Fi extended spectrum in accordance with various embodiments of the disclosure;

FIG. 4 is a flowchart showing a process for establishing a P2P connection over Wi-Fi extended spectrum in accordance with various embodiments of the disclosure;

FIG. 5 is a flowchart showing a process for establishing a P2P connection over Wi-Fi extended spectrum in accordance with various embodiments of the disclosure;

FIG. 6 is a flowchart showing a process for maximizing a channel utilization of a channel in Wi-Fi extended spectrum in accordance with various embodiments of the disclosure;

FIG. 7 is a flowchart showing a process for controlling allocation of channels in Wi-Fi extended spectrum for establishing P2P connections in accordance with various embodiments of the disclosure;

FIG. 8 is a flowchart showing a process for establishing a P2P connection over Wi-Fi extended spectrum in accordance with various embodiments of the disclosure;

FIG. 9 is a flowchart showing a process for establishing a P2P connection over Wi-Fi extended spectrum in accordance with various embodiments of the disclosure; and

FIG. 10 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that enables the use of automated frequency coordination (AFC) prescribed channels (for example, in Wi-Fi extended spectrum, 6 GHz band) for establishing peer-to-peer (P2P) networks. Often bandwidth available for P2P networks is constrained by various factors such as spectrum availability and regulatory limitations on the use of specific frequency bands. These limitations can lead to bandwidth scarcity, particularly in congested wireless environments. Enabling the use of AFC prescribed channels (for example, Wi-Fi extended spectrum, 6 GHz band) that offer high bandwidth and low congestion to establish P2P networks may overcome the above issues. The 6 GHz band, also referred to as the “Wi-Fi extended spectrum”, is a frequency range allocated for wireless communication. The 6 GHz band is designated for Wi-Fi 6E, which is an extended version of Wi-Fi 6 that operates in the 6 GHz frequency range.

In many embodiments, an access point (AP) may receive from an AFC system, a list of frequencies that the AP can use without causing interference to incumbent users. The list of frequencies may include frequencies in the Wi-Fi extended spectrum (for example, 6 GHz band) along with various other frequencies (e.g., frequencies in the 2.4 Ghz and 5 Ghz bands). In a number of embodiments, the AP may receive a channel availability request from a network device (e.g., a user device) to inquire regarding channel availability in the Wi-Fi extended spectrum for establishing a P2P connection. Based on the channel availability request, the AP may determine what all channels in the Wi-Fi extended spectrum are available and transmit, to the network device, a list of one or more channels that are available. The network device may select at least one channel from the one or more channels and transmit a channel selection response to the AP. The channel selection response may be configured to indicate a selection of the channel by the network device. The AP may receive the channel selection response and transmit an acknowledgement to the network device. The acknowledgement may comprise an approval to utilize the selected channel for the P2P connection. Based on the acknowledgement, the network device may establish a P2P connection with a peer device on the selected channel.

In additional embodiments, the network device may further transmit one or more channel utilization parameters to the AP. For example, the channel selection response may be further configured to indicate the one or more channel utilization parameters. In more examples, one or more messages or frames indicating the one or more channel utilization parameters may be transmitted to the AP. Examples of the one or more channel utilization parameters may include, but are not limited to, a duration of channel utilization, a transmission power, an identifier of the peer device, or a bandwidth utilization. The AP may transmit the acknowledgement if the one or more channel utilization parameters are acceptable. For example, the network device may further indicate to the AP the duration of utilization of the selected channel. If the duration of utilization is not acceptable to the AP, the AP may negotiate with the network device to use the selected channel for a shorter duration. The AP may transmit the acknowledgement based on the network device agreeing to use the selected channel for a shorter duration. In some embodiments, where the network device declines to use the selected channel for a shorter duration, the AP may prompt the network device to select an alternate channel from the transmitted one or more channels.

In more embodiments, the network device may further transmit one or more management frames to the AP. The one or more management frames may be configured to indicate one or more characteristics of an intended network traffic of the selected channel. In a variety of embodiments, the AP may predict a channel utilization value of the selected channel based on the intended network traffic. The AP may further compare the channel utilization value with a threshold utilization value. In response to the channel utilization value being less than the threshold utilization value, the AP may offer the same selected channel to other network devices for establishing concurrent P2P connections. However, the AP may declare the selected channel unavailable for more concurrent P2P connections in response to the channel utilization value being greater than or equal to the threshold value. In other words, the AP may attempt to maximize channel utilization by offering the same channel to multiple network devices to establish concurrent P2P connections.

In further embodiments, the AP may set one or more usage conditions for the network device to use the selected channel. For example, the AP may set a coverage area such that the network device may only be permitted to communicate with the peer device on the selected channel while being within the coverage area. In still more embodiments, while communicating with the peer device on the selected channel, the network device may monitor the one or more usage conditions. The network device may release the selected channel if any of the set usage conditions is breached. For example, the network device may execute one or more ranging operations to detect its location. The network device may release the selected channel if the network device crosses a geographical boundary of the coverage area. In more examples, the network device may release the selected channel upon expiration of a utilization duration allocated by the AP for the use of the selected channel. In still further embodiments, the network device may release the selected channel once the requirement of the P2P connection ceases to exist. In still additional embodiments, the AP can reclaim the released channel for reuse.

In some more embodiments, the network device and the peer device may each be associated with a unique AP. In such embodiments, the P2P connection between the network device and the peer device can be established over a Wi-Fi extended spectrum channel that is commonly allocated to both APs by the AFC system. In certain embodiments, the AFC system may reserve one or more channels in the Wi-Fi extended spectrum for P2P connections. In yet more embodiments, the AP can advertise the one or more channels reserved for the P2P connections to other network devices in beacon frames.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

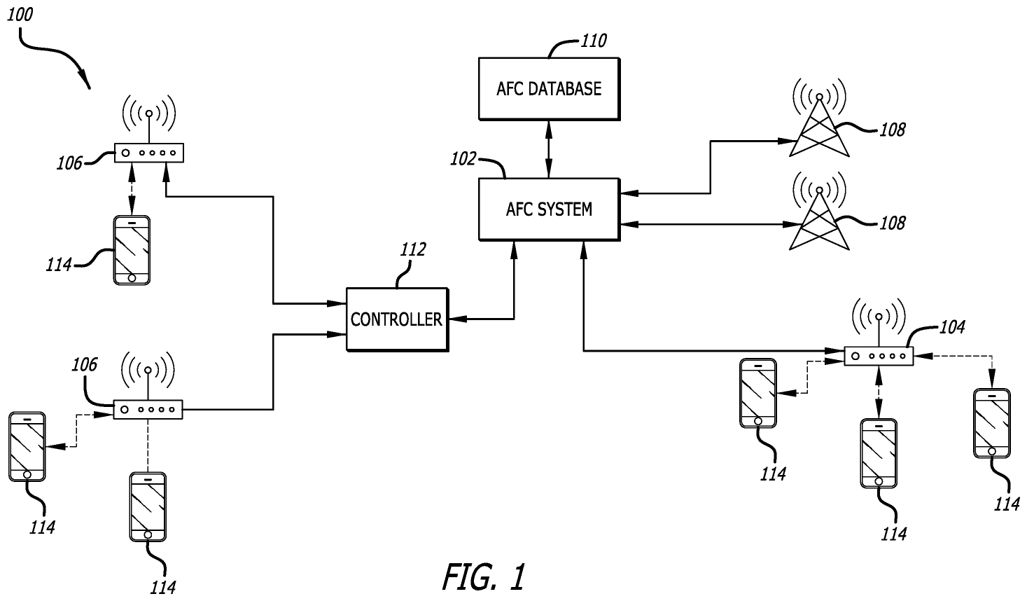

Referring to FIG. 1, a conceptual block diagram illustrating a wireless communication network 100 in accordance with various embodiments of the disclosure is shown. The embodiments depicted in the conceptual block diagram of FIG. 1 may show a scenario where an automated frequency coordination (AFC) system 102 is communicatively coupled to various network devices to provide wireless network access.

In many embodiments, the AFC system 102 may be a central or distributed system that provides lists of frequencies available for use by 802.11 based devices, for example, access points (APs) 104, 106. The AFC system 102 may further maintain information related to all incumbent users 108 in a geographical area. The information related to the incumbent users 108 may include information about various frequencies assigned to or being used by the incumbent users 108. Examples of the incumbent users 108 may include, but are not limited to, satellite links, fixed microwave links, broadcast services, radar systems, weather sensors, or radio astronomy observatories. The AFC system 102 may utilize the incumbent users' information to determine the frequencies available for use by the APs 104, 106. For example, the AFC system 102 may determine which frequencies (e.g., frequencies in 2.4 Ghz band, 5 Ghz band, and 6 Ghz band) the APs 104, 106 can use at their location without causing interference to the incumbent users 108.

In a number of embodiments, the AFC system 102 may maintain an AFC database 110 that includes the information related to the incumbent users 108. The AFC database 110 may be communicatively coupled to the AFC system 102. Though in the embodiments depicted in FIG. 1 the AFC database 110 is configured as a standalone database, the AFC database 110 can exist in a network device (e.g., an AFC system or an AP), be distributed among various network devices operating in tandem, or remotely operated as part of a cloud-based network management tool without deviating from the scope of the disclosure.

In a variety of embodiments, a standalone AP (for example, the AP 104) may directly connect to the AFC system 102 (for example, through the Internet) to inquire about availability of frequency bands (e.g., frequencies in 2.4 Ghz band, 5 Ghz band, and 6 Ghz band) and to seek approval to operate a wireless network on the permitted frequencies. In some embodiments, multiple APs (for example, the APs 106) may connect to the AFC system 102 through a proxy device (for example, a controller 112). The controller 112 may inquire about availability of frequency bands and seek approval to operate a wireless network on the permitted frequencies on behalf of multiple APs, for example, the APs 106. In more embodiments, the controller 112 can be a wireless local area network (LAN) controller (WLC) that manages the operation of the APs 106. In additional embodiments, the controller 112 can be implemented at an on-premises or cloud-based management platform.

In further embodiments, each AP 104, 106 may receive a list of allocated frequencies (e.g., frequencies in 2.4 Ghz band, 5 Ghz band, and 6 Ghz band) from the AFC system 102. The APs 104, 106 may utilize the allocated frequencies to provide network access to various user devices 114. In still more embodiments, the APs 104, 106 may delegate unused frequency channels in the 6 Ghz band (e.g., Wi-Fi extended spectrum) for peer-to-peer (P2P) connections. For example, a user device 114 intending to establish a P2P connection with another nearby user device may inquire a corresponding AP 104, 106 regarding availability of any frequency channel in the Wi-Fi extended spectrum. The AP 104, 106 may delegate an unused or underutilized frequency channel in the Wi-Fi extended spectrum to the inquiring user device 114 for establishing the P2P connection. As a result, the inquiring user device 114 may be able to establish the P2P connection over the Wi-Fi extended spectrum (e.g., Wi-Fi 6E or the 6 Ghz band).

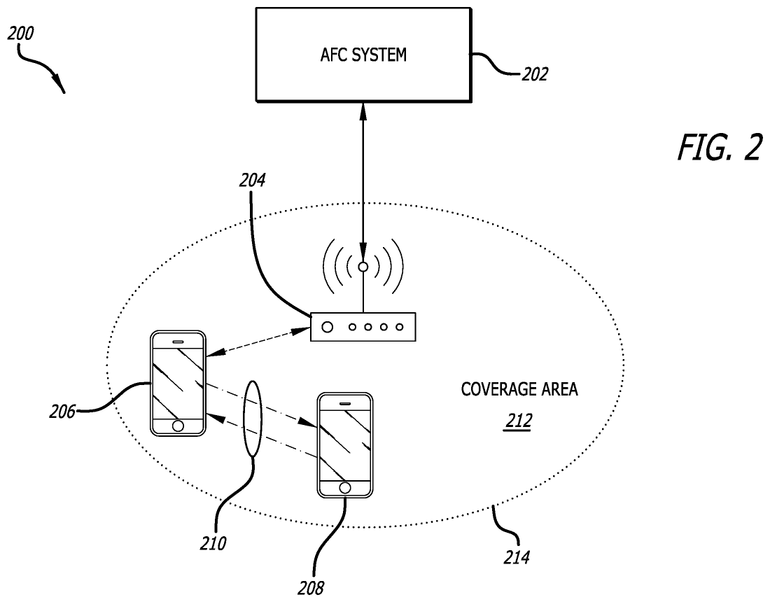

Although a specific embodiment for a wireless communication network suitable for carrying out the various steps, processes, methods, and operations described herein is discussed with respect to FIG. 1, any of a variety of systems and/or processes may be utilized in accordance with embodiments of the disclosure. For example, the AFC system 102 may reserve certain frequency channels in the Wi-Fi extended spectrum for P2P networks and inform the APs 104, 106 regarding the reserved frequency channels. The APs 104, 106 may advertise the reserved channels in their beacon frames. The elements depicted in FIG. 1 may also be interchangeable with other elements of FIGS. 2-10 as required to realize a particularly desired embodiment.

Referring to FIG. 2, a conceptual block diagram 200 illustrating a P2P connection established over the Wi-Fi extended spectrum in accordance with various embodiments of the disclosure is shown. The embodiments depicted in the conceptual block diagram 200 may show a scenario where an AFC system 202 is communicatively coupled to a network device, for example, an AP 204. Though the embodiments depicted in the conceptual block diagram 200 show the AP 204 to be directly coupled to the AFC system 202, the scope of the disclosure may not be limited to these embodiments. The AP 204 can also connect to the AFC system 202 via a controller.

In many embodiments, the AP 204 may receive from the AFC system 202, a list of frequencies allocated to the AP 204 for use. The list of frequencies may include, but not limited to, frequencies in the 2.4 Ghz band, 5 Ghz band, and 6 Ghz band. The AP 204 may delegate unused or underutilized frequency channels in the 6 Ghz band (e.g., Wi-Fi extended spectrum) for P2P connections.

In a number of embodiments, the AP 204 may receive a channel availability request from a first user device 206. The first user device 206 may transmit the channel availability request to check channel availability in the Wi-Fi extended spectrum for establishing a P2P connection with a nearby second user device 208. Examples of various techniques that the first user device 206 can utilize to discover the nearby second user device 208 may include, but are not limited to, Wi-Fi direct, Bluetooth, ultrasound, Bluetooth Low Energy tags, Quick Response codes, image recognition, or Near Field Communication. In a variety of embodiments, the first user device 206 may transmit the channel availability request to the AP 204 via an action frame. The first user device 206 may not need to be authenticated or associated with the AP 204 to transmit the channel availability request.

In some embodiments, based on the channel availability request, the AP 204 may determine one or more channels in the Wi-Fi extended spectrum that are available for use. The AP 204 may determine the one or more available channels by considering bandwidth utilization and interference conditions associated with various channels. For example, the AP 204 may determine a channel to be available when a channel utilization value of the channel is less than a threshold utilization value. In more examples, channels may be associated with varying bandwidth. Thus, the AP 204 may consider those unused or underutilized channels as available which can satisfy the bandwidth requirements for the P2P connection. In yet more examples, the AP 204 may determine those unused or underutilized channels as available channels on which the interference is within tolerance limits to ensure reliable communication. In more embodiments, the AP 204 may further determine one or more parameters associated with the one or more available channels. For example, the AP 204 can determine a power that can be used on each available channel.

In additional embodiments, the AP 204 may transmit a list of the one or more available channels to the first user device 206 for selection. The AP 204 may further transmit the one or more parameters associated with at least one of the one or more available channels to the first user device 206. For example, the AP 204 may inform the first user device 206 that Wi-Fi extended spectrum channels ‘F1’, ‘F2, ‘F3’ having respective powers ‘P1’, ‘P2’, and ‘P3’ are available for establishing the P2P connection. In further embodiments, the AP 204 may populate the list based on an AFC reply the AP 204 had received from the AFC system 202. The AFC reply may be indicative of various frequency channels assigned to the AP 204 for use.

In several embodiments, the first user device 206 may receive the list of one or more available channels and their respective parameters from the AP 204. The first user device 206 may assess the one or more available channels and may select at least one channel to establish the P2P connection (hereinafter, the at least one channel is interchangeably referred to as “the selected channel”). For example, the first user device 206 may select a channel with power parameter satisfying the power requirement of the P2P connection.

In still more embodiments, the first user device 206 may transmit a channel selection response to the AP 204. The channel selection response may be configured to indicate the selection of the at least one channel by the first user device 206. In still further embodiments, the first user device 206 may indicate one or more channel utilization parameters. Examples of the one or more channel utilization parameters may include, but are not limited to, a bandwidth utilization, a duration of utilization of the selected channel, an identifier (e.g., media access control address) of the second user device 208 (e.g., peer device), or one or more characteristics of an intended network traffic of the selected channel. In still additional embodiments, the first user device 206 may transmit one or more management frames configured to indicate the one or more channel utilization parameters to the AP 204. The first user device 206 can transmit the one or more management frames to the AP 204 following the transmission of the channel selection response. In some more embodiments, the first user device 206 may indicate the one or more channel utilization parameters in the channel selection response. For example, the channel selection response can have a message format where different bits are configured to indicate the selected channel and the one or more channel utilization parameters.

In certain embodiments, the AP 204 may receive the channel selection response from the first user device 206. The AP 204 may transmit an acknowledgement to the first user device 206. The acknowledgement can include an approval to utilize the selected channel for the P2P connection. In yet more embodiments, the AP 204 may transmit the acknowledgement if the one or more utilization parameters of the selected channel are acceptable to the AP 204. For example, if the duration of utilization indicated by the first user device 206 is not acceptable to the AP 204, the AP 204 may negotiate with the first user device 206 to use the selected channel for a shorter duration. The AP 204 may transmit a message to the first user device 206 requesting to reduce the duration of utilization of the selected channel. The first user device 206 can accept or decline the request of the AP 204. The AP 204 may transmit the acknowledgement based on the first user device 206 agreeing to use the selected channel for a shorter duration. However, if the first user device 206 declines to use the selected channel for a shorter duration, the AP 204 may prompt the first user device 206 to select an alternate channel that is available for the required duration.

In many further embodiments, the AP 204 may set one or more usage conditions for the selected channel and may transmit information related to the one or more usage conditions to the first user device 206. For example, the AP 204 may set a coverage area 212 within which the first user device 206 is permitted to communicate on the selected channel and may communicate the information related to the coverage area 212 to the first user device 206. The information related to the coverage area can include GPS coordinates of the coverage area 212, a cell radius of the coverage area 212, a maximum distance from the AP 204, identifiers of BLE tags that delimit the coverage area 212, or the like. The AP 204 can transmit the information related to the one or more usage conditions with the acknowledgement or in one or more messages/frames following the acknowledgment.

In still yet more embodiments, the first user device 206 may receive the acknowledgement from the AP 204. In response to the acknowledgement, the first user device 206 may establish a P2P connection 210 with the second user device 208. For example, the first user device 206 may utilize the selected channel in the Wi-Fi extended spectrum to establish the P2P connection 210 with the second user device 208.

In numerous embodiments, the AP 204 may predict a channel utilization value of the selected channel based on the intended network traffic indicated by the first user device 206. For example, the AP 204 may provide the characteristics of the intended network traffic as input to a machine learning model and the machine learning model may predict the channel utilization value as output. The AP 204 may compare the channel utilization value with a threshold utilization value to determine if the selected channel is expected to be utilized optimally. For example, if the channel utilization value is determined to be less than the threshold utilization value based on the comparison, the AP 204 may offer the same selected channel to other user devices for establishing concurrent P2P connections. However, if the channel utilization value is determined to be greater than or equal to the threshold utilization value based on the comparison, the AP 204 may declare the selected channel unavailable for more concurrent P2P connections. The threshold utilization value can be a configurable value that is set based on interference tolerance limits. For example, the threshold utilization value can be dependent on a type of data or services associated with the P2P connections. In other words, the AP 204 may attempt to maximize the channel utilization of the Wi-Fi extended spectrum by offering the same channels to multiple user devices to establish concurrent P2P connections.

In many additional embodiments, the AP 204 may establish a radio frequency (RF) impact zone for the first user device 206 based on the indication of the power (e.g., transmitting power) that the first user device 206 intends to utilize on the selected channel. “Zone of RF impact” or “RF impact zone” may refer to an area or a region that can be affected by a particular RF signal. For example, when the first user device 206 transmits an RF signal to the second user device 208 using the selected channel, the RF signal can interfere with other devices operating on similar frequencies within a certain range. Determining the zone of RF impact may involve assessing the strength and a reach of the RF signal. The AP 204 may further determine, based on the RF impact zone, a threshold count of connected network device pairs that are allowed to coexist in a geographical area associated with the RF impact zone without significant interference. The AP 204 may control channel allocation in the geographical area based on the threshold count of connected network device pairs. For example, the AP 204 may not allocate more channels to user devices when the count of the connected network device pairs is equal to the threshold count.

In still yet further embodiments, while communicating with the second user device 208 on the selected channel, the first user device 206 may monitor the one or more usage conditions set by the AP 204. The first user device 206 may terminate the P2P connection 210 to release the selected channel if any of the usage conditions are breached. For example, the first user device 206 may execute one or more ranging operations (e.g., fine timing measurement, received signal strength indicator measurement, ultrawideband ranging, or the like) to detect its location (e.g., distance from the AP 204) or a location of the connected second user device 208. The first user device 206 may terminate the P2P connection 210 and release the selected channel if the detected location of any of the first user device 206 or the second user device 208 is outside a geographical boundary 214 associated with the coverage area 212. In more examples, the first user device 206 may release the selected channel once the requirement of the P2P connection 210 ceases to exist, e.g., data transfer is complete. In yet more examples, the first user device 206 may further terminate the P2P connection 210 and release the selected channel based on the expiration of the utilization duration allocated by the AP 204. The first user device 206 can also inform the AP 204 regarding the release of the channel so that the AP 204 can reuse the released channel for new P2P connection requests. For example, the first user device 206 can transmit a channel release indication to the AP 204 to indicate that the selected channel is not released. The channel release indication may end a lease agreement between the AP 204 and the first user device 206 regarding the allocation of the selected channel to the first user device 206 for the P2P connection 210.

In numerous additional embodiments where the requirement of the P2P connection 210 still exists and the utilization duration has expired, the first user device 206 may transmit an extension request to the AP 204 to extend the utilization duration of the selected channel. The AP 204 can accept or decline the extension request. The AP 204 can further request the first user device 206 to migrate the P2P connection 210 to another Wi-Fi extended spectrum channel in case the extension of the currently utilized channel is not permissible. The first user device 206 can also transmit a new channel availability request to another nearby AP (e.g., a neighboring AP) if the first user device 206 has crossed the geographical boundary 214 or a cell served by the AP 204 and the requirement of the P2P connection 210 still persists.

In still yet additional embodiments, the first user device 206 may monitor an interference level or quality of service (QOS) on the selected channel. In those embodiments where the first user device 206 determines that the interference level is beyond a tolerance level or that the QoS is lower than an acceptable QoS, the first user device 206 may request the AP 204 to delegate a new channel in the Wi-Fi extended spectrum for migrating the P2P connection 210 or establishing a new P2P connection with the second user device 208. In several more embodiments, the first user device 206 may further communicate a list of channels that the first user device 206 wants to avoid due to expected high interference or expected low QoS on those channels.

In further additional embodiments, the AP 204 may serve as relay between the first user device 206 and the AFC system 202. For example, the AP 204 may transmit the channel availability request received from the first user device 206 to the AFC system 202 and may forward the list of the one or more channels received from the AFC system 202 to the first user device 206. In more examples, the AP 204 can generate the channel availability request on behalf of the first user device 206 and transmit the generated channel availability request to the AFC system 202. In such embodiments, the AP 204 may utilize a temporary identifier to transmit the channel availability request to the AFC system 202 on behalf of the first user device 206. The temporary identifier may be configured to indicate to the AFC system 202 that the channel availability request is on behalf of a user device and is not initiated by the AP 204. The temporary identifier can be generated by the AP 204 or the first user device 206 without deviating from the scope of the disclosure.

Although a specific embodiment for a P2P connection established over the wireless extended spectrum suitable for carrying out the various steps, processes, methods, and operations described herein is discussed with respect to FIG. 2, any of a variety of systems and/or processes may be utilized in accordance with embodiments of the disclosure. For example, a user device may further terminate a P2P connection, release the currently used 6 Ghz channel when a corresponding AP ceases to operate as a service provider device, and request another nearby AP for a new 6 Ghz channel. The elements depicted in FIG. 2 may also be interchangeable with other elements of FIGS. 1 and 3-10 as required to realize a particularly desired embodiment.

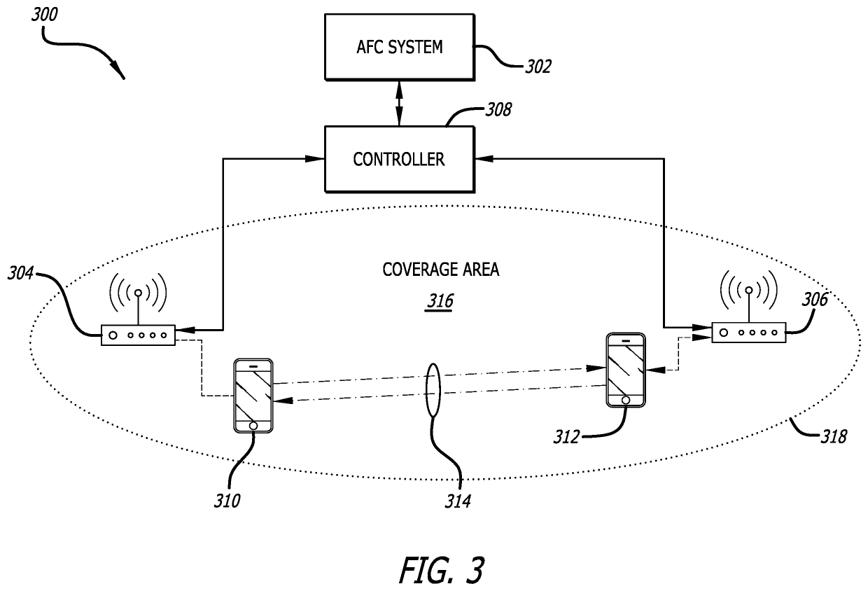

Referring to FIG. 3, a conceptual block diagram 300 illustrating a P2P connection established over the Wi-Fi extended spectrum in accordance with various embodiments of the disclosure is shown. The embodiments depicted in the conceptual block diagram 300 may show a scenario where an AFC system 302 is communicatively coupled to a plurality of network devices, for example, a first AP 304 and a second AP 306. The embodiments depicted in the conceptual block diagram 300 may further show a scenario where the AFC system 302 is communicatively coupled to the first AP 304 and the second AP 306 via a controller 308.

In many embodiments, the controller 308 can be a wireless local area network (LAN) controller (WLC) that manages the operations of the first AP 304 and the second AP 306. In a number of embodiments, the controller 308 may orchestrate coordination between the first AP 304 and the second AP 306, optimizing resource utilization across the network. For example, the controller 308 may have information regarding the list of frequencies (e.g., frequencies in 2.4 Ghz band, 5 Ghz band, and 6 Ghz band) allocated to each of the first AP 304 and the second AP 306 by the AFC system 302.

In a variety of embodiments, the first AP 304 may receive a channel availability request from a first user device 310. The first user device 310 may transmit the channel availability request to check channel availability in the Wi-Fi extended spectrum for establishing a P2P connection with a nearby second user device 312. The first user device 310 and the second user device 312 may each be associated with a unique AP. For example, the first user device 310 may be associated with the first AP 304 and the second user device 312 may be associated with the second AP 308.

In some embodiments, the first user device 310 may also transmit an identifier of the second user device 312 to the first AP 304 along with the channel availability request. In more embodiments, the first AP 304 may transmit the channel availability request and identifiers of the first user device 310 and the second user device 312 to the controller 308. In response to receiving the channel availability request and identifiers of the first user device 310 and the second user device 312, the controller 308 may determine whether the first user device 310 and the second user device 312 are each associated with the same AP or with unique APs. For example, the controller 308 may be configured to maintain client statistics data for each associated AP. The client statistics data may include identifiers of different user devices associated with the first AP 304 and the second AP 306. Based on the client statistics data, the controller 308 may determine whether the first user device 310 and the second user device 312 are each associated with the same AP or with unique APs. As depicted in the embodiments of FIG. 3, the controller 308 may determine that the first user device 310 is associated with the first AP 304 and the second user device 312 is associated with the second AP 306.

In additional embodiments, the controller 308 may identify those channels in the Wi-Fi extended spectrum that are available and that are commonly allocated to the first AP 304 and the second AP 306 by the AFC system 302. The controller 308 may transmit information about the identified channels to the first AP 304. In further embodiments, the first AP 304 may transmit a list of the identified channels to the first user device 310 for selection. In still more embodiments, the first AP 304 may determine one or more channels from the identified channels and transmit a list of the one or more channels to the first user device 310. For example, the first AP 304 may determine the one or more channels by considering bandwidth and interference conditions associated with various channels.

In still further embodiments, the first user device 310 may assess the one or more available channels and may select at least one channel to establish the P2P connection with the second user device 312. In still additional embodiments, the first user device 206 may transmit a channel selection response to the first AP 304. The channel selection response may be configured to indicate the selection of the at least one channel by the first user device 310.

In some more embodiments, the first AP 304 may receive the channel selection response from the first user device 310. The first AP 304 may transmit an acknowledgement to the first user device 310. The acknowledgement can include an approval to utilize the selected channel for the P2P connection. In certain embodiments, the first AP 304 may further transmit the acknowledgement to the controller 308. The controller 308 may forward the acknowledgement to the second AP 306 to inform that the channel has been approved for establishing a P2P connection.

In yet more embodiments, the first user device 310 may receive the acknowledgement from the first AP 304. In response to the acknowledgement, the first user device 310 may establish a P2P connection 314 with the second user device 312. For example, the first user device 310 may utilize the selected channel in the Wi-Fi extended spectrum to establish the P2P connection 314 with the second user device 312.

In still yet more embodiments, the first AP 304 may set a coverage area 316 within which the first user device 310 and the second user device 312 are permitted to communicate on the selected channel. The first AP 304 may communicate the information related to the coverage area 316 to the first user device 310. In many further embodiments, while communicating with the second user device 312 on the selected channel, the first user device 310 may execute one or more ranging operations to detect its location or a location of the connected second user device 312. The first user device 310 may terminate the P2P connection 314 and release the selected channel if any of the first user device 310 or the second user device 312 has crossed a geographical boundary 318 associated with the coverage area 316.

In numerous embodiments, when the first AP 304 receives a channel availability request in the Wi-Fi extended spectrum for a P2P connection from a user device, the first AP 304 may determine a likelihood of roaming for the user device. In numerous additional embodiments, the first AP 304 may utilize telemetry data associated with the user device and predict potential roaming trajectories of the user device. In a scenario where the first AP 304 determines that the user device is highly likely to roam to cells of nearby or neighboring APs based on the predicted roaming trajectories, the first AP 304 may request the controller 308 to provide a list of available Wi-Fi extended spectrum channels associated with the nearby APs. In response, the first AP 304 may receive the list of available channels in the Wi-Fi extended spectrum from the controller 308. The first AP 304 may further transmit a per-AP list of available channels to the user device as a response to the channel availability request. The user device can select one channel per AP and establish a lease agreement with the first AP 304 and the nearby APs. As a result, the user device can utilize allocated channels as per the lease agreement and roam freely from one cell to another without having to terminate the P2P connection established over the Wi-Fi extended spectrum. For example, the user device may switch the P2P connection from one allocated channel to another allocated channel in the lease agreement as the user device moves from one cell to another.

Although a specific embodiment for a P2P connection established over the wireless extended spectrum suitable for carrying out the various steps, processes, methods, and operations described herein is discussed with respect to FIG. 3, any of a variety of systems and/or processes may be utilized in accordance with embodiments of the disclosure. For example, in response to a channel availability request from a user device, an AFC system or an associated AP may provide a list of available channels in the Wi-Fi extended spectrum to the user device for selection. Each available channel may be associated with a unique location, thus enabling the user device to switch the P2P connection from one available channel to another available channel in the Wi-Fi extended spectrum as the user device roams across different locations. The elements depicted in FIG. 3 may also be interchangeable with other elements of FIGS. 1-2 and 4-10 as required to realize a particularly desired embodiment.

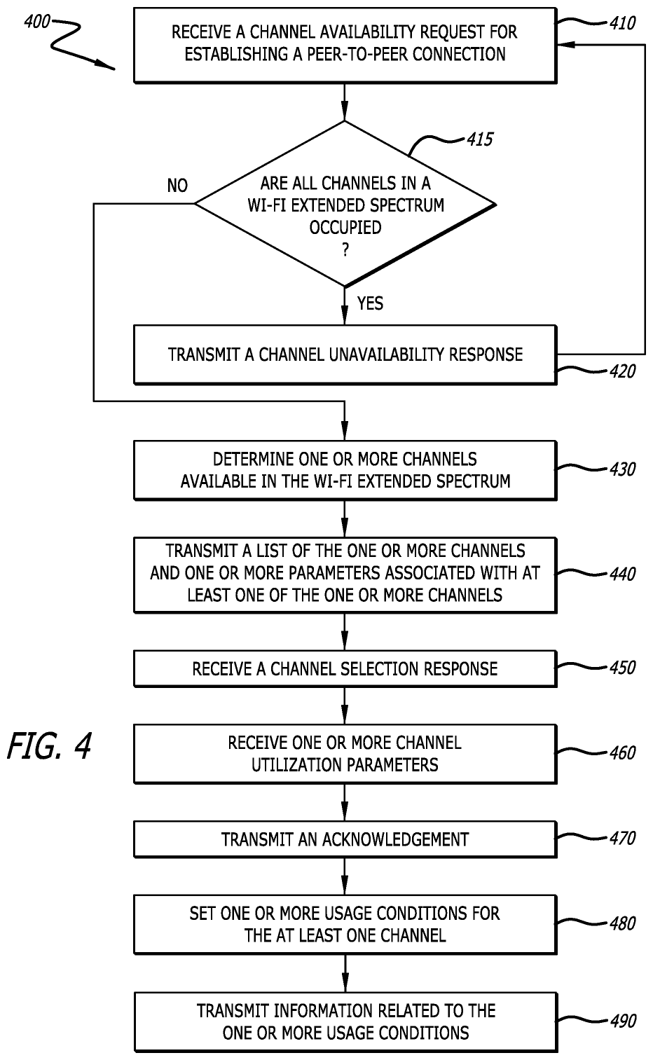

Referring to FIG. 4, a flowchart showing a process 400 for establishing a P2P connection over the Wi-Fi extended spectrum in accordance with various embodiments of the disclosure is shown. In many embodiments, the process 400 may receive a channel availability request for establishing a P2P connection (block 410). The channel availability request may be configured to indicate an intention of a user device to establish a P2P connection over the Wi-Fi extended spectrum. In a number of embodiments, the channel availability request may be generated by the user device and received by an AP from the user device. The channel availability request can be received via an action frame from the user device. In a variety of embodiments, the channel availability request may be generated on behalf of the user device by the AP and may include a temporary identifier that is configured to indicate that the channel availability request is an on-behalf request. In such an embodiment, the channel availability request may be received by an AFC system from the AP. In some embodiments, the channel availability request may be generated by the user device and received by the AFC system with the AP serving as a relay in between.

In more embodiments, the process 400 may determine whether all channels (e.g., channels allocated to the AP) in the Wi-Fi extended spectrum are occupied (block 415). The determination regarding whether a channel in the Wi-Fi extended spectrum is occupied or available can be made based on a channel utilization value associated with the corresponding channel. For example, if the channel utilization value of the channel is less than a threshold utilization value, the channel may be determined as available; however, if the channel utilization value of the channel is greater than or equal to the threshold utilization value, the channel may be determined as unavailable. Examples of additional or alternate factors that can be utilized by the process 400 for determining whether a channel is occupied or available may include, but are not limited to, a bandwidth utilization of the channel, a power being transmitted on the channel, or an interference level of the channel. In additional embodiments when all channels allocated to the AP in the Wi-Fi extended spectrum are occupied, the process 400 may transmit a channel unavailability response (block 420) and wait to receive a new channel availability request (block 410). The channel unavailability response may be transmitted to the user device.

However, when all channels allocated to the AP in the Wi-Fi extended spectrum are not occupied, the process 400 may determine one or more channels available in the Wi-Fi extended spectrum (block 430). In further embodiments, the one or more available channels may be determined based on various factors, for example, but not limited to, a bandwidth utilization, interference conditions, power transmissions, or the like. In still more embodiments, one or more parameters associated with the one or more available channels are also determined. The one or more parameters may include, but not limited to, a power that can be used to transmit on each available channel.

In still further embodiments, the process 400 may transmit a list of the one or more channels and the one or more parameters associated with at least one of the one or more channels (block 440). The list of the one or more channels and the one or more parameters associated with at least one of the one or more channels may be transmitted to the user device for selection. In still additional embodiments, the list of the one or more channels and the one or more parameters may be populated in accordance with an AFC reply the AP had received from the AFC system.

In some more embodiments, the process 400 may receive a channel selection response (block 450). The channel selection response may be received from the user device. The channel selection response may be configured to indicate a selection of at least one channel by the user device from the one or more available channels to establish the P2P connection. In certain embodiments, the at least one channel may be selected based on one or more functional requirements associated with the P2P connection, for example, a type of application that is to be executed, a power required to transmit data to a peer device located at a certain distance from the user device, or the like.

In yet more embodiments, the process 400 may receive one or more channel utilization parameters (block 460). The one or more channel utilization parameters may be received from the user device. The one or more channel utilization parameters may indicate how the selected channel will be used for the P2P connection. Examples of the one or more channel utilization parameters may include, but are not limited to, a bandwidth utilization, a duration of utilization of the selected channel, an identifier (e.g., media access control address) of the peer device, or one or more characteristics of an intended network traffic of the selected channel. The one or more channel utilization parameters can be received in the channel selection response or can be received separately via one or more management frames.

In still yet more embodiments, the process 400 may transmit an acknowledgement (block 470). The acknowledgement may be transmitted to the user device in response to the channel selection response. The acknowledgement can include an approval to utilize the selected channel for the P2P connection. In many further embodiments, the acknowledgement can be transmitted if the one or more utilization parameters associated with the selected channel are acceptable.

In many additional embodiments, the process 400 may set one or more usage conditions for the at least one channel (block 480). Examples of the one or more usage conditions may include, but are not limited to, a maximum duration of utilization, an allowed maximum power for transmission, a coverage area within which the selected channel can be utilized for establishing the P2P connection, or the like.

In still yet further embodiments, the process 400 may transmit information related to the one or more usage conditions (block 490). The information related to the one or more usage conditions may be transmitted to the user device. In still yet additional embodiments, the information related to the one or more usage conditions can be transmitted in the acknowledgement. In several embodiments, the information related to the one or more usage conditions can be transmitted separately in one or more messages/frames following or concurrently with the acknowledgment.

Although a specific embodiment for establishing a P2P connection over the Wi-Fi extended spectrum suitable for carrying out the various steps, processes, methods, and operations described herein is discussed with respect to FIG. 4, any of a variety of systems and/or processes may be utilized in accordance with embodiments of the disclosure. For example, the user device may monitor the one or more usage conditions and may terminate the P2P connection if any of the one or more usage conditions are breached. The elements depicted in FIG. 4 may also be interchangeable with other elements of FIGS. 1-3 and 5-10 as required to realize a particularly desired embodiment.

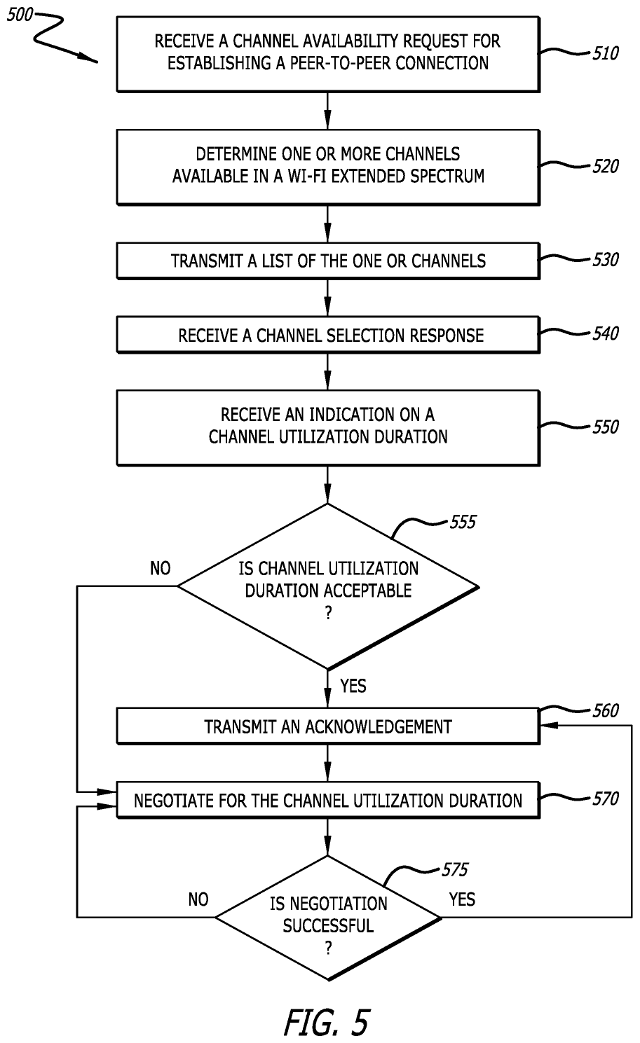

Referring to FIG. 5, a flowchart showing a process 500 for establishing a P2P connection over the Wi-Fi extended spectrum in accordance with various embodiments of the disclosure is shown. In many embodiments, the process 500 may receive a channel availability request for establishing a P2P connection (block 510). The channel availability request may be configured to indicate an intention of a user device to establish a P2P connection over the Wi-Fi extended spectrum. In a number of embodiments, the channel availability request may be generated by the user device and received by an AP from the user device. The channel availability request can be received via an action frame from the user device. In a variety of embodiments, the channel availability request may be generated on behalf of the user device by the AP, and may include a temporary identifier that is configured to indicate that the channel availability request is an on-behalf request. In such an embodiment, the channel availability request may be received by an AFC system from the AP. In some embodiments, the channel availability request may be generated by the user device and received by the AFC system with the AP serving as a relay in between.

In more embodiments, the process 500 may determine one or more channels available in the Wi-Fi extended spectrum (block 520). In further embodiments, the one or more available channels may be determined based on various factors (for example, but not limited to, bandwidth utilization, interference conditions, power transmissions, or the like) associated with the channels. In still more embodiments, one or more parameters associated with the one or more available channels may be determined. The one or more parameters may include, but not limited to, a power that can be used to transmit on each available channel.

In still further embodiments, the process 500 may transmit a list of the one or more channels (block 530). The list of the one or more channels may be transmitted to the user device for selection. In numerous embodiments, information regarding the one or more parameters associated with the one or more channels may also be transmitted to the user device.

In some more embodiments, the process 500 may receive a channel selection response (block 540). The channel selection response may be received from the user device. The channel selection response may be configured to indicate a selection of at least one channel, from the one or more available channels, by the user device to establish the P2P connection. In certain embodiments, the at least one channel may be selected based on one or more functional requirements associated with the P2P connection, for example, a type of application that is to be executed, a power required to transmit data to a peer device located at a certain distance from the user device, or the like.

In yet more embodiments, the process 500 may receive an indication on a channel utilization duration (block 550). The indication on the channel utilization duration may be received from the user device. The indication on the channel utilization duration may provide information on how long the user device intends to use the selected channel for the P2P connection. The indication on the channel utilization duration can be received in the channel selection response or can be received separately via one or more management frames.

In more embodiments, the process 500 may determine whether the channel utilization duration is acceptable (block 555). For example, the process 500 may determine a usage schedule associated with the selected channel to determine if the selected channel is available for the requested duration. The usage schedule may be obtained from the AFC system.

In additional embodiments when the channel utilization duration is acceptable, the process 500 may transmit an acknowledgement (block 560). The acknowledgement may be transmitted to the user device in response to the channel selection response. The acknowledgement can include an approval to utilize the selected channel for the P2P connection for the requested channel utilization duration. In numerous embodiments, the acknowledgement may represent a lease agreement between the user device and the AP/the AFC system, ensuring that the AP/the AFC system may not utilize the selected channel for any other access services except the P2P network.

However, when the channel utilization duration is not acceptable, the process 500 may negotiate for the channel utilization duration (block 570). For example, based on the channel usage schedule of the selected channel, the process 500 may determine that the selected channel is unavailable for the requested channel utilization duration. Thus, the process 500 may negotiate with the user device for a shorter channel utilization duration.

In additional embodiments when the negotiation is successful, the process 500 may transmit the acknowledgement (block 560). However, when a first round of negotiation is unsuccessful, the process 500 may perform one more rounds of negotiation with the user device until an agreement is reached (block 575). For example, in further rounds of negotiation, one or more alternate channels may be suggested to the user device that are available for the requested channel utilization duration.

Although a specific embodiment for establishing a P2P connection over the Wi-Fi extended spectrum suitable for carrying out the various steps, processes, methods, and operations described herein is discussed with respect to FIG. 5, any of a variety of systems and/or processes may be utilized in accordance with embodiments of the disclosure. For example, an AP or an AFC system can also negotiate with the user device for lesser bandwidth utilization or lower power transmission on the selected channel. The elements depicted in FIG. 5 may also be interchangeable with other elements of FIGS. 1-4 and 6-10 as required to realize a particularly desired embodiment.

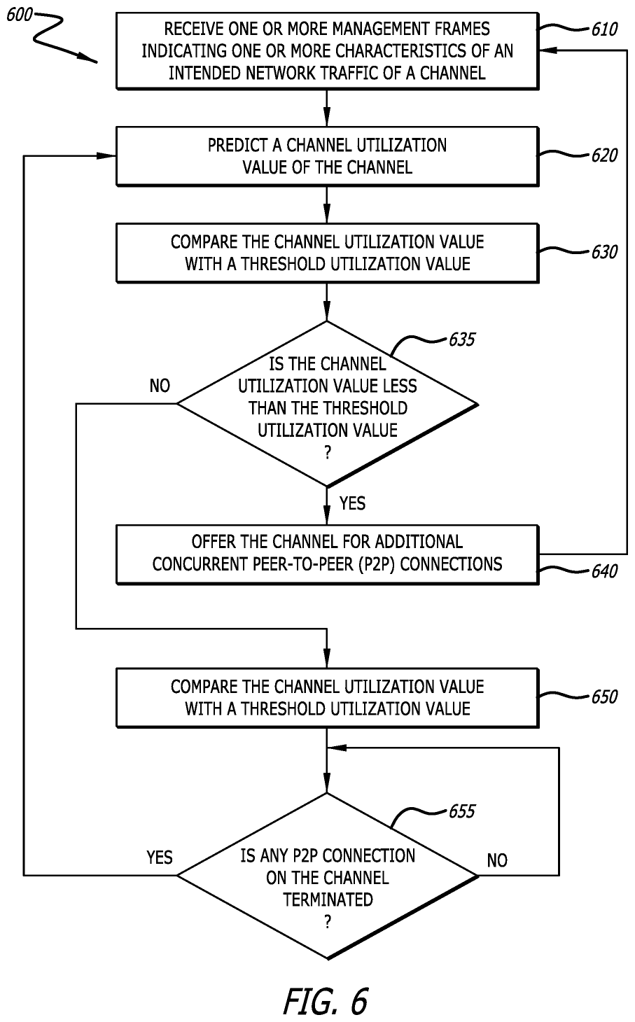

Referring to FIG. 6, a flowchart showing a process 600 for maximizing a channel utilization of a channel in the Wi-Fi extended spectrum in accordance with various embodiments of the disclosure is shown. In many embodiments, the process 600 may receive one or more management frames indicating one or more characteristics of an intended network traffic of a channel (block 610). The one or more management frames may be transmitted by a user device that has selected the channel (e.g., a channel in the 6 Ghz band) for establishing a P2P connection. The one or more characteristics of the intended network traffic may refer to various attributes and properties that describe a behavior of intended data flow over the channel. Examples of the one or more characteristics may include, but are not limited to, a volume of traffic, a type of traffic, a directionality of traffic (e.g., unidirectional or bidirectional), a packet size, a type of protocol, or a service application service associated with the data flow.

In a number of embodiments, the process 600 may predict a channel utilization value of the channel (block 620). In a variety of embodiments, the channel utilization value may be predicted based on a machine learning model. For example, the one or more characteristics of the intended network traffic and one or more characteristics of current network traffic on the channel may be provided as an input to the machine learning model and the channel utilization value may be predicted as an output of the machine learning model. The channel utilization value may be configured to indicate an extent to which a specific communication channel or a frequency band is expected to be utilized by active transmissions or intended transmissions.

In numerous embodiments, the process 600 may compare the channel utilization value with a threshold utilization value (block 630). The channel utilization value may be compared with the threshold utilization value to determine if the channel is being used optimally. In certain embodiments, a result of the comparison can be a Boolean value, for example, ‘1’ or ‘0’, ‘true’ or ‘false’, or the like.

In some embodiments, the process 600 may check whether the channel utilization value is less than the threshold utilization value (block 635). When the channel utilization value is less than the threshold utilization value, the channel may be considered as underutilized and hence can be considered available. When the process 600 determines that the channel utilization value is less than the threshold utilization value, the process 600 may offer the channel for additional concurrent P2P connections (block 640). By offering the channel for additional concurrent P2P connections, the channel utilization value is expected to increase.

However, when the process 600 determines that the channel utilization value is greater than or equal to the threshold utilization value, the process 600 may declare the channel unavailable for an additional P2P connection (clock 650). In other words, when the channel utilization value equals the threshold utilization value, the channel may be considered to be operating at a desired level of efficiency and capacity utilization. Offering the channel to more P2P connections when the threshold utilization value is reached may degrade a QoS associated with the channel, hence, the channel may be declared unavailable.

In more embodiments, the process 600 may check whether any P2P connection on the channel is terminated (block 655). The process 600 may periodically or continuously monitor any of the P2P connections established on the channel is terminated. Termination of any P2P connection on the channel may release certain bandwidth of the channel, which can be reused for new P2P connections.

When the process 600 determines that no P2P connection on the channel is terminated, the process 600 may continue checking (block 655). However, when at least one P2P connection on the channel is terminated, the process 600 may again predict a new channel utilization value for the channel (block 620). In other words, the channel utilization of the Wi-Fi extended spectrum can be maximized by offering the same channels to multiple user devices to establish concurrent P2P connections.

Although a specific embodiment for maximizing the channel utilization of the channel in the Wi-Fi extended spectrum suitable for carrying out the various steps, processes, methods, and operations described herein is discussed with respect to FIG. 6, any of a variety of systems and/or processes may be utilized in accordance with embodiments of the disclosure. For example, the threshold utilization value can be a configurable parameter that can be set based on types of applications and type of data associated with the channel. The elements depicted in FIG. 6 may also be interchangeable with other elements of FIGS. 1-5 and 7-10 as required to realize a particularly desired embodiment.

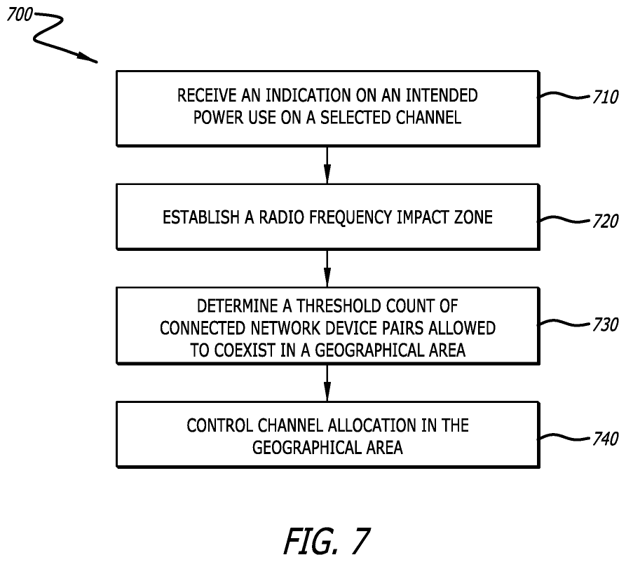

Referring to FIG. 7, a flowchart showing a process 700 for controlling allocation of channels in the Wi-Fi extended spectrum for establishing P2P connections in accordance with various embodiments of the disclosure is shown. In many embodiments, the process 700 may receive an indication regarding an intended power use on a selected channel (block 710). In a number of embodiments, the indication regarding the intended power use may be received from a user device that has selected the channel in the Wi-Fi extended spectrum to establish a P2P connection. The intended power use may refer to an amount of power the user device intends to utilize to transmit data over the selected channel during the P2P connection. For example, the intended power use may represent a strength of an RF signal that the user device intends to transmit over the selected channel after the P2P connection is established.

In more embodiments, the process 700 may establish an RF impact zone. “Zone of RF impact” or “RF impact zone” may refer to an area or a region that can be affected by a particular RF signal (block 720). Determining the zone of RF impact may involve assessing the strength and a reach of the RF signal that the user device intends to transmit over the selected channel after the P2P connection is established.

In further embodiments, the process 700 may determine a threshold count of connected network device pairs allowed to coexist in a geographical area (block 730). The threshold count of connected network device pairs may refer to a maximum number of device pairs that can concurrently communicate within the geographical area without causing significant interference to each other. In some more embodiments, the process 700 may control channel allocation in the geographical area (block 740). The channel allocation in the geographical area may be controlled based on the threshold count of connected network device pairs. For example, more channels may not be allocated to user devices when the connected network device pairs in the geographical area equals the threshold count.

Although a specific embodiment for controlling the allocation of channels in the Wi-Fi extended spectrum for establishing P2P connections suitable for carrying out the various steps, processes, methods, and operations described herein is discussed with respect to FIG. 7, any of a variety of systems and/or processes may be utilized in accordance with embodiments of the disclosure. For example, a user device may monitor an interference level during the P2P connection and may request an AP to assign a new channel in the Wi-Fi extended spectrum if the interference level is beyond a tolerance limit. The elements depicted in FIG. 7 may also be interchangeable with other elements of FIGS. 1-6 and 8-10 as required to realize a particularly desired embodiment.

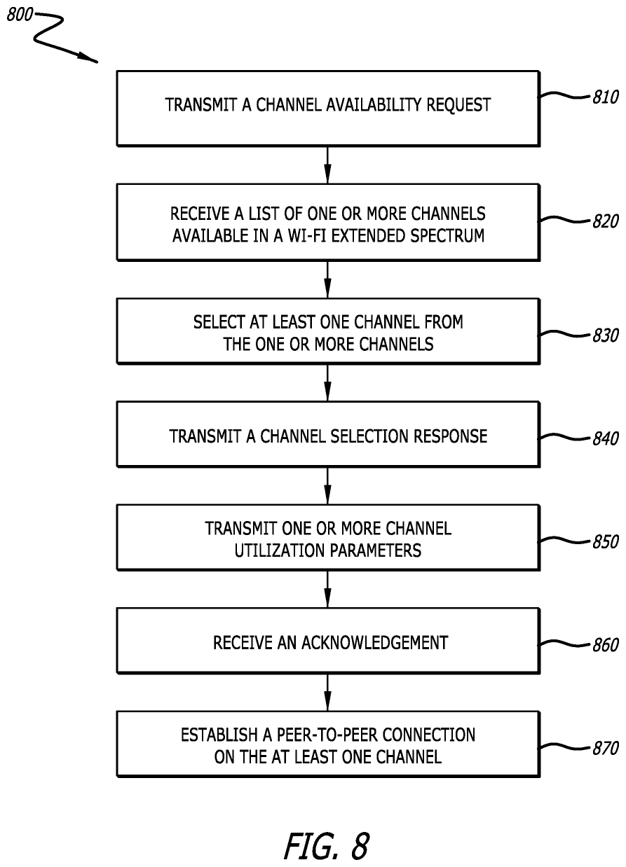

Referring to FIG. 8, a flowchart showing a process 800 for establishing a P2P connection over the Wi-Fi extended spectrum in accordance with various embodiments of the disclosure is shown. In many embodiments, the process 800 may transmit a channel availability request (block 810). The channel availability request may be configured to indicate an intention of a user device to establish a P2P connection over the Wi-Fi extended spectrum. In a number of embodiments, the channel availability request may be generated by the user device and transmitted to an AP. In numerous embodiments, the channel availability request can be transmitted via an action frame, thus eliminating a need for the user device to be authenticated or associated with the AP.

In more embodiments, the process 800 may receive a list of one or more channels in the Wi-Fi extended spectrum (block 820). The list of the one or more channels may be received from the AP for selection. In numerous additional embodiments, one or more parameters associated with the one or more channels may also be received. Examples of the one or more parameters may include a power that can be utilized to transmit on each channel.

In some more embodiments, the process 800 may select at least one channel from the one or more channels (block 830). In certain embodiments, the at least one channel may be selected based on one or more functional requirements associated with the P2P connection. Examples of the one or more functional requirements may include, but are not limited to, a type of application that is to be executed, a power required to transmit data to a peer device located at a certain distance from the user device, or the like.

In some more embodiments, the process 800 may transmit a channel selection response (block 840). The channel selection response may be transmitted to the AP. The channel selection response may be configured to indicate at least one channel selected by the user device to establish the P2P connection. For example, the channel selection response may be configured to indicate an identifier of the selected channel.

In yet more embodiments, the process 800 may transmit one or more channel utilization parameters (block 850). The one or more channel utilization parameters may be transmitted to the AP. The one or more channel utilization parameters may indicate how the selected channel will be used for the P2P connection. Examples of the one or more channel utilization parameters may include, but are not limited to, a bandwidth utilization, a duration of utilization of the selected channel, an identifier (e.g., media access control address) of a peer device, or one or more characteristics of an intended network traffic of the selected channel. The one or more channel utilization parameters can be transmitted in the channel selection response or can be transmitted separately via one or more management frames.

In still yet more embodiments, the process 800 may receive an acknowledgement (block 860). The acknowledgement may be received from the AP in response to the channel selection response. The acknowledgement can include an approval to utilize the selected channel for the P2P connection. In many further embodiments, the acknowledgement can be received if the one or more utilization parameters associated with the selected channel are acceptable to the AP.

In many additional embodiments, the process 800 may establish a P2P connection on the at least one channel (block 870). The P2P connection may be established to communicate with the peer device. As a result, the user device can leverage the high bandwidth and the high speed of the Wi-Fi extended spectrum (e.g., the 6 Ghz band) for P2P communication.

Although a specific embodiment for establishing a P2P connection over the Wi-Fi extended spectrum suitable for carrying out the various steps, processes, methods, and operations described herein is discussed with respect to FIG. 8, any of a variety of systems and/or processes may be utilized in accordance with embodiments of the disclosure. For example, a user device may monitor one or more usage conditions while communicating with the peer device on a Wi-Fi extended spectrum channel and may terminate the P2P connection if any of the one or more usage conditions is breached. The elements depicted in FIG. 8 may also be interchangeable with other elements of FIGS. 1-7 and 9-10 as required to realize a particularly desired embodiment.

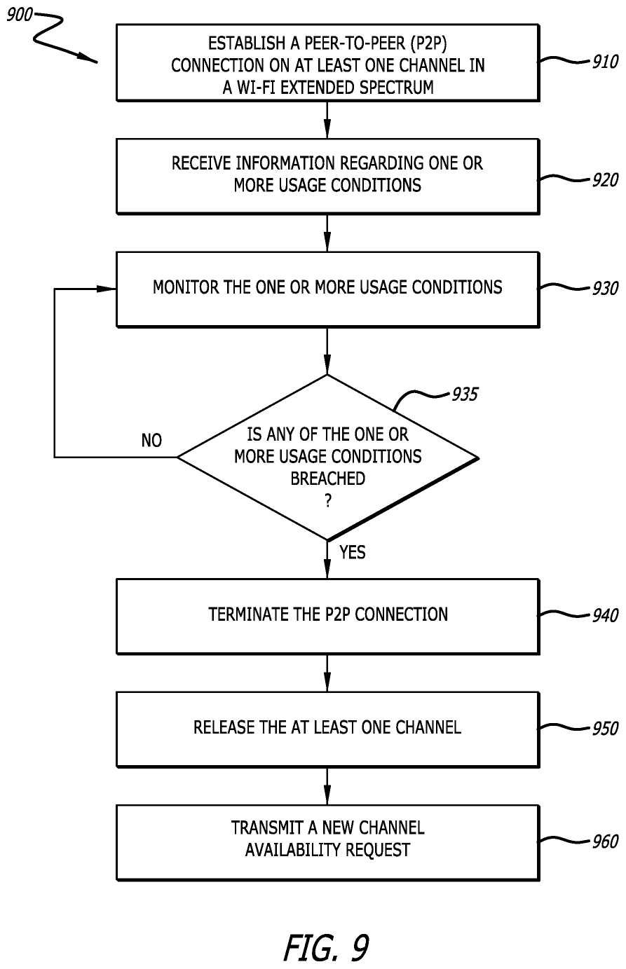

Referring to FIG. 9, a flowchart showing a process 900 for establishing a P2P connection over the Wi-Fi extended spectrum in accordance with various embodiments of the disclosure is shown. In many embodiments, the process 900 may establish a P2P connection on at least one channel in the Wi-Fi extended spectrum (block 910). The P2P connection may be established by a user device with a peer device. In a number of embodiments, the peer device can be associated with the same AP as the user device. In a variety of embodiments, the user device and the peer device may be associated with unique APs, e.g., different APs. In some embodiments, the user device may have obtained access to the channel in the Wi-Fi extended spectrum by transmitting a channel availability request to corresponding AP. In more embodiments, the user device may have selected a channel from reserved channels in the Wi-Fi extended spectrum for P2P networks.

In additional embodiments, the process 900 may receive information regarding one or more usage conditions (block 920). Examples of the one or more usage conditions may include, but are not limited to, a maximum allowed duration of utilization, an allowed maximum power for transmission, a coverage area within which the selected channel can be utilized for establishing the P2P connection, or the like. The information related to the one or more usage conditions may be received from an AP. In further embodiments, the information related to the one or more usage conditions can be received in the acknowledgement from the AP. In still more embodiments, the information related to the one or more usage conditions can be received separately in one or more messages/frames following or concurrently with the acknowledgment.

In still further embodiments, the process 900 may monitor the one or more usage conditions (block 930). For example, locations of the user device and the peer device may be detected and monitored to ensure that the user device and the peer device are within the coverage area. To detect the location, various ranging operations such as fine timing measurement, received signal strength indicator measurement, ultrawideband ranging, or the like can be executed. In more examples, the transmission power for P2P communication can be monitored to ensure that used power is below the allowed maximum power.

In still additional embodiments, the process 900 may check if any of the one or more usage conditions are breached (block 935). Based on the monitoring of the one or more usage conditions, it can be determined if any of the usage conditions is breached. For example, a condition for the coverage may be determined as breached, when the user device or the peer device crosses a geographical boundary associated with the coverage area. In more examples, a usage condition may breach upon expiration of the duration of utilization of the channel.

When no condition is breached, the process 900 may continue the monitoring until the P2P connection is not terminated (block 930). However, when any of the condition is breached, the process 900 may terminate the P2P connection (block 940). For example, if the user device or the peer device crosses the geographical boundary associated with the coverage area, the P2P connection between the user device and the peer device may be terminated. In more examples, the P2P connection between the user device and the peer device may be terminated upon the expiration of the duration of utilization of the channel.

In some more embodiments, the process 900 may release the at least one channel (block 950). The least one channel can be released to allow the reuse of the channel. A channel release indication may be provided by the user device to the AP to indicate that the channel has been released. Based on the channel release agreement, the AP may end the lease agreement with the user device for the assigned channel. The AP may reclaim the channel when the lease agreement is ended and can re-allocate the channel to another user device. In numerous embodiments, the lease agreement can further end if the user device moves outside the coverage area without informing the AP and the AP detects an absence of the user device within the coverage area.

In certain embodiments, the process 900 may transmit a new channel availability request (block 960). In some examples, even after the termination of the P2P connection, there may persist a requirement of the P2P connection. In such examples, the channel availability request may be transmitted to gain access to a new channel in the Wi-Fi extended spectrum for establishing a new P2P connection.

Although a specific embodiment for establishing a P2P connection over the Wi-Fi extended spectrum suitable for carrying out the various steps, processes, methods, and operations described herein is discussed with respect to FIG. 9, any of a variety of systems and/or processes may be utilized in accordance with embodiments of the disclosure. For example, a user device may transmit an extension request to the AP to seek an extension in the utilization duration of the currently utilized channel when the requirement of the P2P connection still persists, and the utilization duration has expired. The elements depicted in FIG. 9 may also be interchangeable with other elements of FIGS. 1-8 and 10 as required to realize a particularly desired embodiment.

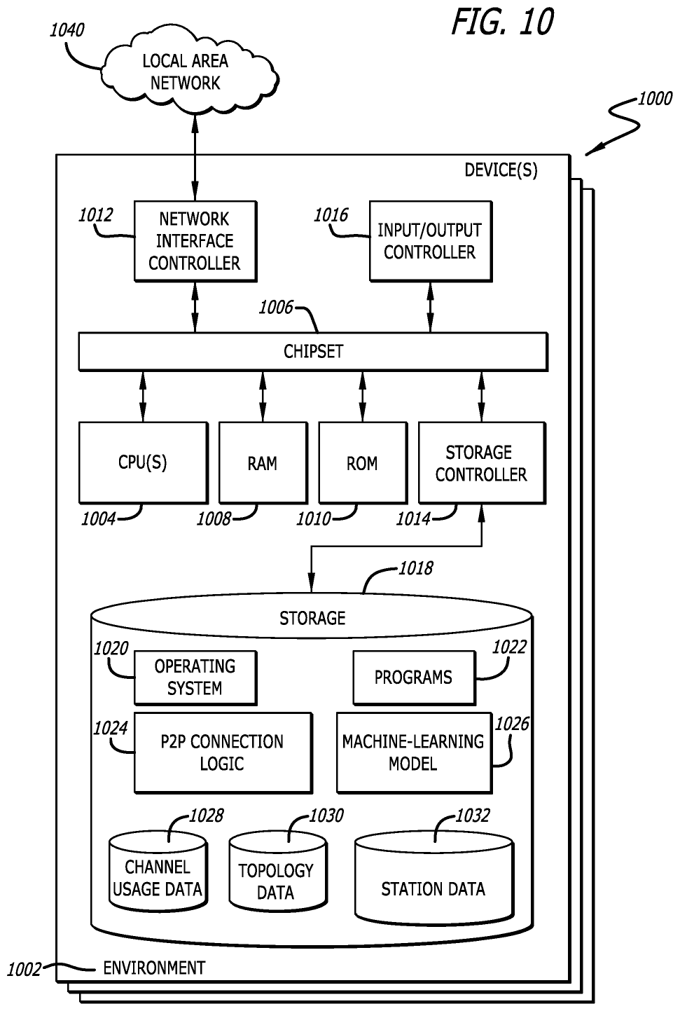

Referring to FIG. 10, a conceptual block diagram for one or more devices 1000 capable of executing components and logic for implementing the functionality and embodiments described above is shown. The embodiment of the conceptual block diagram depicted in FIG. 10 can illustrate a conventional server computer, workstation, desktop computer, laptop, tablet, network appliance, e-reader, smartphone, or other computing device, and can be utilized to execute any of the application and/or logic components presented herein. The device 1000 may, in some examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In additional embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for example, store an operating system 1020, applications 1022, and data 1028, 1030, 1032, which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In various embodiment, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In more embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10, and can include other components that are not explicitly shown in FIG. 10, or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In many embodiments, the device 1000 can include a P2P connection logic 1024 that can be configured to perform one or more of the various steps, processes, operations, and/or other methods that are described above. Often, the P2P connection logic 1024 can be a set of instructions stored within a non-volatile memory that, when executed by the processor(s)/controller(s) 1004 can carry out these steps, etc. In some embodiments, the P2P connection logic 1024 may be a client application that resides on a network-connected device, such as, but not limited to, a server, switch, personal or mobile computing device, an AP. In certain embodiments, the P2P connection logic 1024 can enable the utilization of frequency channels in the Wi-Fi extended spectrum (e.g., 6 Ghz band) for establishing P2P networks (e.g., an adhoc network). Thus, allowing devices to leverage the advantages of the Wi-Fi extended spectrum for P2P communication.

In several embodiments, the P2P connection logic 1024 can enable the device 1000 (for example, an AP) to determine and/or select channels in the Wi-Fi extended spectrum for establishing P2P connections. The P2P connection logic 1024 may further control resource allocation in the Wi-Fi extended spectrum to maximize channel utilization and improve QoS. The P2P connection logic 1024 may further perform various operations that enable a user device to establish a P2P connection with a peer device over the Wi-Fi extended spectrum.

In a number of embodiments, the storage 1018 can include channel usage data 1028. In some embodiments, channel usage data 1028 can include information related to frequency channels in the Wi-Fi spectrum (e.g., frequencies in 2.4 Ghz band, 5 Ghz band, and 6 Ghz band). For example, the channel usage data 1028 may include information on network traffic, channel utilization values, interference levels, noise levels, client distributions, or channel availability of each channel. The channel usage data 1028 can be utilized for managing and optimizing Wi-Fi channel allocation.

In various embodiments, the storage 1018 can include topology data 1030. The topology data 1030 can comprise information detailing the physical or logical arrangement of network devices and their interconnections. This data can provide insights into the structure of the network, including the relationships between routers, switches, servers, and other components. Topology data 1030 can describe the actual layout of devices, such as their placement in a building or across multiple locations, while logical topology data may focus on the communication paths and relationships between devices regardless of their physical location. Understanding network topology is crucial for troubleshooting, optimizing performance, and planning for scalability. It can enable network administrators to identify potential points of failure, ensure efficient data flow, and make informed decisions about network expansion or reconfiguration. Advanced tools and technologies are often employed to visualize and analyze topology data 1030, aiding in the effective management and maintenance of complex network infrastructures. In further embodiments, topology data 1030 can enable identification of one or more target network devices that can serve a roaming user device (e.g., the device 1000).

In still more embodiments, the storage 1018 can include station data 1032. Station data 1032 may comprise detailed information about individual devices or stations connected to the network. This data includes unique identifiers known as MAC addresses assigned to each wireless device, indicating their presence on the network. Station data 1032 can encompass the current connection status of each device, indicating whether it is actively connected or not. Additionally, it can provide insights into signal strength, offering information about the quality of the wireless connection. Station data 1032 may also comprise data usage metrics which specify the amount of data transmitted and received by each device, aiding in network traffic analysis. Authentication status details may be available regarding whether a device has successfully undergone the authentication process to access the network, and IP addresses are assigned to facilitate communication within the network. In more embodiments, the station data 1032 can include monitoring data crucial for network administrators to optimize network performance, troubleshoot connectivity issues, and manage resources effectively, providing a comprehensive view of the devices interacting within the wireless environment. Advanced network management tools can offer real-time insights into station data, empowering administrators to make informed decisions regarding network optimization and security.

Finally, in many embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026. The ML model 1026 may be configured to learn roaming pattern of user devices and generate predictions regarding potential roaming trajectories of moving user devices. In some embodiments, the ML model 1026 may be implemented to predict channel utilization values of allocated frequency channels to ensure that the channels are being optimally utilized.

The ML model(s) 1026 can be configured to generate inferences to make predictions or draw conclusions from data. An inference can be considered the output of a process of applying a model to new data. This can occur by learning from infrastructure data, sustainability data, and/or health data and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises a peer-to-peer (P2P) connection logic that is configured to:
receive, from a network device, a channel availability request for establishing a P2P connection;
determine, based on the channel availability request, one or more channels in a Wi-Fi extended spectrum that are available; and
transmit, to the network device, at least a list of the one or more channels selectable for establishing the P2P connection.

2. The device of claim 1, wherein the P2P connection logic is further configured to transmit power information associated with at least one of the one or more channels.

3. The device of claim 1, wherein the P2P connection logic is further configured to receive a channel selection response configured to indicate a selection of at least one channel of the one or more channels.

4. The device of claim 3, wherein the channel selection response is further configured to indicate at least one of: a bandwidth utilization, a duration of utilization of the at least one channel, or an identifier of a peer device for establishing the P2P connection.

5. The device of claim 3, wherein the P2P connection logic is further configured to transmit an acknowledgement to the network device, and wherein the acknowledgement comprises an approval to utilize the at least one channel for the P2P connection.

6. The device of claim 5, wherein the P2P connection logic is further configured to set a coverage area for the at least one channel such that the network device is permitted to communicate on the at least one channel within the coverage area.

7. The device of claim 6, wherein the P2P connection logic is further configured to communicate information associated with the coverage area to the network device.

8. The device of claim 3, wherein the P2P connection logic is further configured to receive one or more management frames from the network device, and wherein at least one of the one or more management frames is configured to indicate one or more characteristics of an intended network traffic for the P2P connection.

9. The device of claim 8, wherein the P2P connection logic is further configured to predict a channel utilization value for the intended network traffic of the at least one channel.

10. The device of claim 9, wherein the P2P connection logic is further configured to compare the predicted channel utilization value with a threshold utilization value.

11. The device of claim 10, wherein, in response to the predicted channel utilization value being less than the threshold utilization value, the P2P connection logic is further configured to offer the at least one channel to one or more other network devices for concurrent P2P connection establishment.

12. The device of claim 10, wherein, in response to the predicted channel utilization value being greater than or equal to the threshold utilization value, the P2P connection logic is further configured to declare the at least one channel unavailable for an additional P2P connection.

13. The device of claim 3, wherein the P2P connection logic is further configured to receive an indication of a power that the network device intends to utilize on the at least one channel.

14. The device of claim 13, wherein the P2P connection logic is further configured to:
establish a radio frequency impact zone for the network device based on the indication of the power; and
determine, based on the radio frequency impact zone, a threshold count of connected network device pairs allowed to coexist in a geographical area.

15. A device, comprising:
a processor;
a network interface controller configured to provide access to a network; and
a memory communicatively coupled to the processor, wherein the memory comprises a peer-to-peer (P2P) connection logic that is configured to:
transmit, to a network device, a channel availability request for establishing a P2P connection;
receive, from the network device, at least a list of one or more channels available in a Wi-Fi extended spectrum for establishing the P2P connection;
select at least one channel from the list of one or more channels; and
establish the P2P connection on the at least one channel with a peer device.

16. The device of claim 15, wherein the P2P connection logic is further configured to release the at least one channel based on an expiration of an allocated utilization duration.

17. The device of claim 15, wherein the P2P connection logic is further configured to release the at least one channel based on the device crossing a geographical boundary associated with the at least one channel.

18. The device of claim 17, wherein the P2P connection logic is further configured to:
detect a location of the device; and
determine whether the device has crossed the geographical boundary based on the detected location.

19. The device of claim 15, wherein the device and the peer device are each associated with a unique network device.

20. A method comprising:
receiving, from a network device, a channel availability request for establishing a peer-to-peer (P2P) connection;
determining, based on the channel availability request, one or more channels in a Wi-Fi extended spectrum that are available; and
transmitting, to the network device, at least a list of the one or more channels selectable for establishing the P2P connection.
